(19) United States
(12) Patent Application Publication
(10) Pub. No.: US 2026/0218739 A1
(43) Pub. Date: Jul. 30, 2026

(54) POLE CONNECTOR

(71) Applicant: JAMESON, LLC, Clover, SC (US)

(72) Inventor: Carlos Fernando Becerra Alvarado, Charlotte, NC (US)

(21) Appl. No.: 19/038,173

(22) Filed: Jan. 27, 2025

(51) Int. Cl. F16B 7/18

(52) U.S. Cl. CPC F16B 7/182

(57) ABSTRACT

A connector system includes a cylindrical core, a cylindrical first pole, and a cylindrical tube, each having a proximal end and a distal end and each extending along a longitudinal axis. The first pole includes a cylindrical hollow interior in which the proximal end of the core is received. The tube includes a cylindrical hollow interior in which the distal end of the first pole is received. An annular space is defined within the interior of the tube between the tube and core, the annular space extending longitudinally from the distal end of the first pole to the distal end of the tube. The distal end of the core extends longitudinally beyond the distal end of the tube.

### TECHNICAL FIELD

The present disclosure relates to poles and connections therefor. More particularly, the present disclosure relates to a pole extension system for elongating a tool handle.

### BACKGROUND

A variety of industries have the need to dig holes in the ground that are both deep and of small diameter/area. While holes can be quickly and efficiently completed with special machines, there is also a need to dig these holes by hand, using only hand tools.

Manufacturers thus provide special digging tools for this purpose, which have some features that are specific for this purpose. The most important of these features is a long handle, capable of allowing a good grip of the tools, even when the actual digging head is several feet deep below the ground surface. These handles are usually made of wood for rigidity and typically measure 10 feet, even up to 16 feet.

Because of sales volumes, these tools are transported using typically available commercial transportation methods, such as FedEx or UPS. Transportation companies such as these charge premiums for transporting packages that exceed a certain length (usually 75 inches), imposing additional premiums when exceeding larger sizes. This increases the final cost of these products, which reduce sales margins and/or sales volumes.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

A connector system, according to at least one embodiment, includes a cylindrical core, a cylindrical first pole, and a cylindrical tube. The core has a proximal end, a distal end, and a central portion between the proximal end and the distal end. The core extends along a longitudinal axis. The first pole extends along the longitudinal axis and includes a proximal end, a distal end, and a cylindrical hollow interior in which the proximal end of the core is received. The tube extends along the longitudinal axis and includes a proximal end, a distal end, and a cylindrical hollow interior in which the distal end of the first pole is received. An annular space for receiving a second pole is defined within the interior of the tube between the tube and core, the annular space extending longitudinally from the distal end of the first pole to the distal end of the tube. The distal end of the core extends longitudinally beyond the distal end of the tube.

The proximal end of the core may extend longitudinally beyond the proximal end of the tube.

Approximately one half of a longitudinal length of the core may be received by the interior of the first pole.

A fastener may be received in each of a hole defined by the tube, a hole defined by the first pole, and a hole defined by the core.

In some examples, the system includes at least one fastener, and the core includes multiple through holes, each through hole passing perpendicularly through the longitudinal axis, the through holes mutually parallel and spaced along the longitudinal axis by a uniform distance. In such examples, the first pole includes multiple mounting holes spaced by the same uniform distance, a particular mounting hole of said mounting holes being aligned with a particular through hole of said through holes; the tube includes multiple receiving holes spaced by the same uniform distance, a particular receiving hole of said receiving holes being aligned with the particular mounting hole; and the at least one fastener is received at least in part by each of the particular receiving hole, the particular mounting hole, and the particular through hole.

The at least one fastener may include a bolt and a barrel nut.

A cylindrical second pole may also extend along the longitudinal axis, the second pole including a proximal end received in the annular space, a distal end, and a cylindrical hollow interior in which the distal end of the core is received.

The distal end of the first pole may abut the proximal end of the second pole.

A first fastener may be received at least in part in each of a first receiving hole defined by the tube, a mounting hole defined by the first pole, and a first through hole defined by the core; and a second fastener received at least in part in each of a second receiving hole defined by the tube, a mounting hole defined by the second pole, and a second through hole defined by the core.

A tool head may be attached to the distal end of the second pole.

The tool head in various non-limiting examples includes a shovel head, a tamping head, and a blade.

The cylindrical core may be a solid cylindrical core.

The cylindrical core may include wood. The first pole may include a fibrous composite. The tube may include steel.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1A is a perspective view of a distal end of a connector system, according to at least one embodiment, showing at least a portion of each of a core, a tube, fasteners, and a first pole shown as shortened or partial for illustration of other components in detail is a single drawing.

FIG. 1B is a perspective view of a proximal end of a connector system of FIG. 1A.

FIG. 2 is an end view of the connector system of FIG. 1 taken along a longitudinal axis to show the distal end.

FIG. 3 is an end view of the connector system of FIG. 1A taken along the longitudinal axis to show the proximal end.

FIG. 4 is a perspective view as in FIG. 1A, showing laterally arranged fasteners separated.

FIG. 5 is a perspective view as in FIG. 1A, showing a second pole aligned for coupling to the connector system of FIG. 4.

FIG. 6 is a perspective view as in FIG. 5, showing the proximal end of the second pole coupled to the connector system.

FIG. 7 illustrates the second pole fixed with the connector system by the fasteners, showing a side termed as dorsal for descriptive convention.

FIG. 8 is a lateral view of the ventral side of the assembly of FIG. 7.

FIG. 9 is a lateral view of the dorsal side of the assembly of FIG. 7 taken opposite the perspective of FIG. 8.

FIG. 10 is a lateral view of the assembly of FIG. 7 taken perpendicularly to the perspective of FIG. 8 to show a first flank side, of which a second flank side opposite the first flank side would appear as a mirror image.

FIG. 11 is an exploded view of the assembly of FIGS. 7-10.

FIG. 12 is an exploded view of the assembly taken at a perspective rotated around the longitudinal axis relative to the perspective of FIG. 11.

FIG. 13 is lateral dorsal side view of a digging tool shown as a shovel, according to one embodiment, for use with the connector system of FIG. 1A.

FIG. 14 is perspective view of digging tool shown as a tamping tool, according to an embodiment alternative to that of FIG. 13, for use with the connector system of FIG. 1A.

FIG. 15 is a side view of a digging tool shown as a post hole digger, according to an embodiment alternative to those of FIGS. 13-14, for use with the connector system of FIG. 1A.

FIG. 16 is a lateral view of the ventral side of the connector system of FIG. 1A, showing an even longer version of the first pole or a complete view thereof, representing a connector system for use with a digging tool such as any of those of FIGS. 13-15.

FIG. 17 is an improved digging tool effected by assembly of the tool of FIG. 13 with the connector system of FIG. 16.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and/or in these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing. Inventive products and methods for production thereof need not literally ever be implemented as expressly illustrated in the drawings, in which rectangular, linear, cylindrical and/or other simple geometric graphical representations are shown. The drawings are to be taken as conceptual, representative, exemplary, and non-limiting. Each drawing nonetheless does literally represent at least an embodiment of its illustrated subject matter.

Any materials described are provided as non-limiting examples except where their inclusion is positively and unambiguously asserted. Once materials and arrangements are described herein with reference to any structures and elements thereof, for example in the drawings, such descriptions apply as well to any further same or similar structures and elements that may appear in other drawings. Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

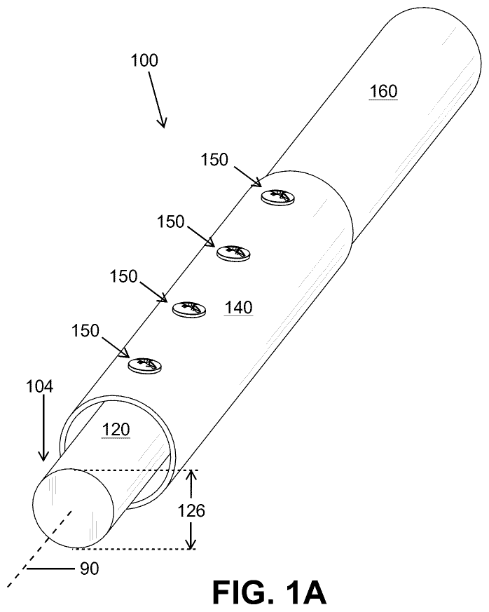

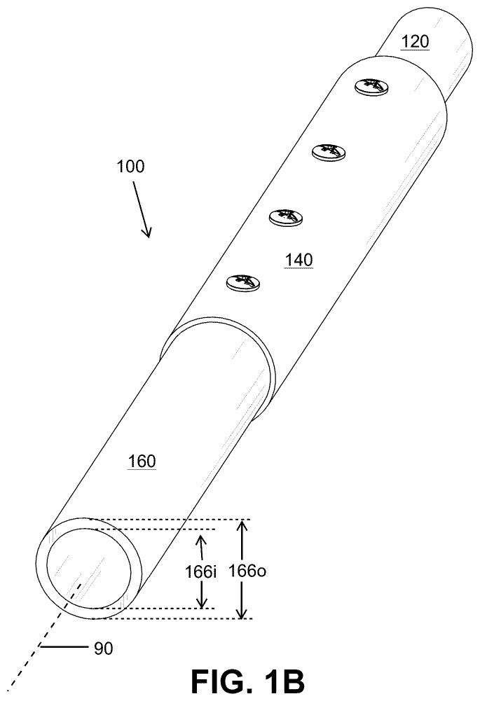

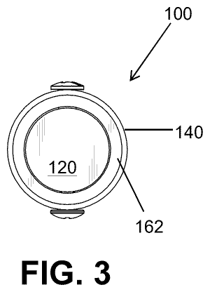

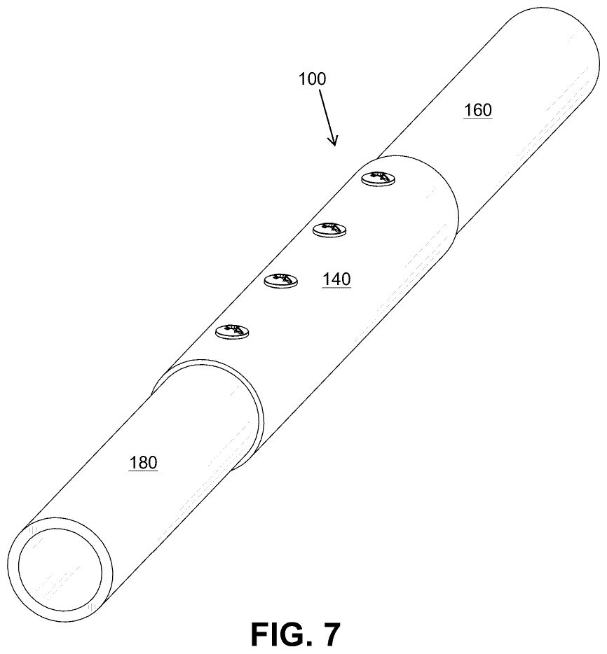

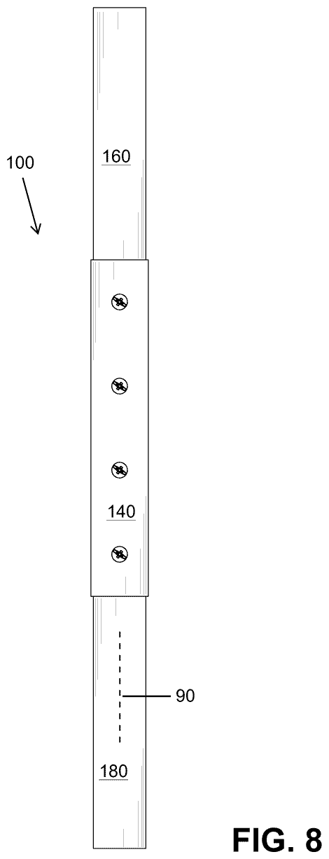

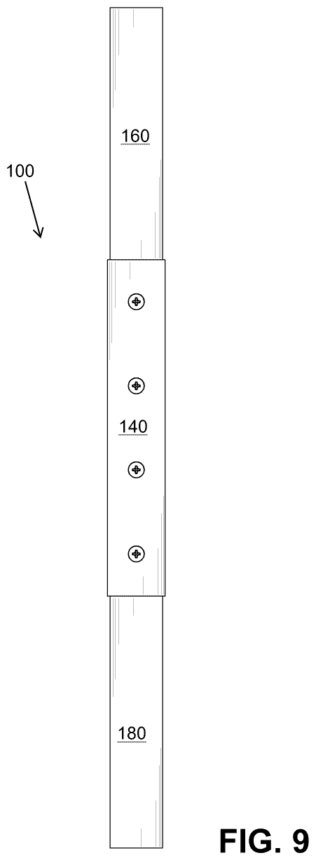

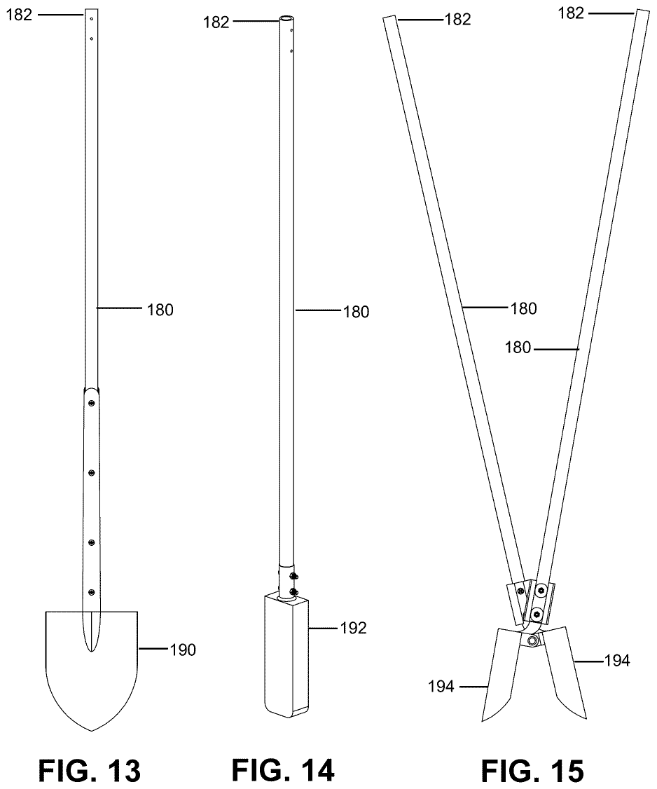

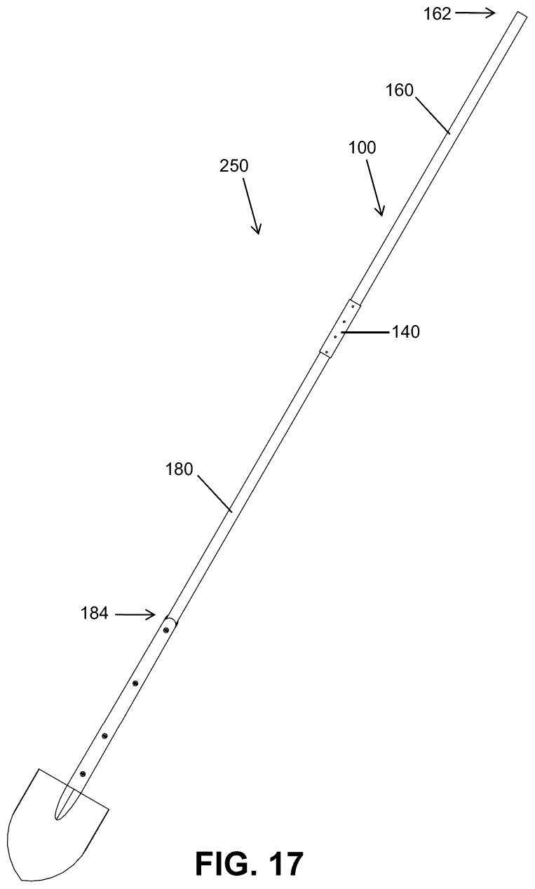

These descriptions reference, in FIGS. 13-15, digging tools that utilize fiberglass poles as handles. These handles provide as much rigidity and strength as the typical wooden counterparts, but at a fraction of the weight. These descriptions detail a connector system 100 (FIGS. 1A-12, 16) that allows separate pole segments to be joined in such a way that yields a longer assembled handle. Joints are made of materials that provide good sturdiness and rigidity, such that the longer assembled handle continues to be as rigid and reliable as a corresponding one-piece counterpart. The assembly process is also simple and requires only standard tools, allowing the end user to easily assemble a long-handled tool, of which FIG. 17 provides a non-limiting example.

Having the ability to join separate segments to create a longer handle allows for a very long digging tool to be shipped unassembled in a smaller package. As a result, shipping costs decrease. The lighter fiberglass poles used in at least some embodiments also contribute to lower shipping costs. These cost savings can be passed to the consumer, translating into higher margins and/or increased sales volumes.

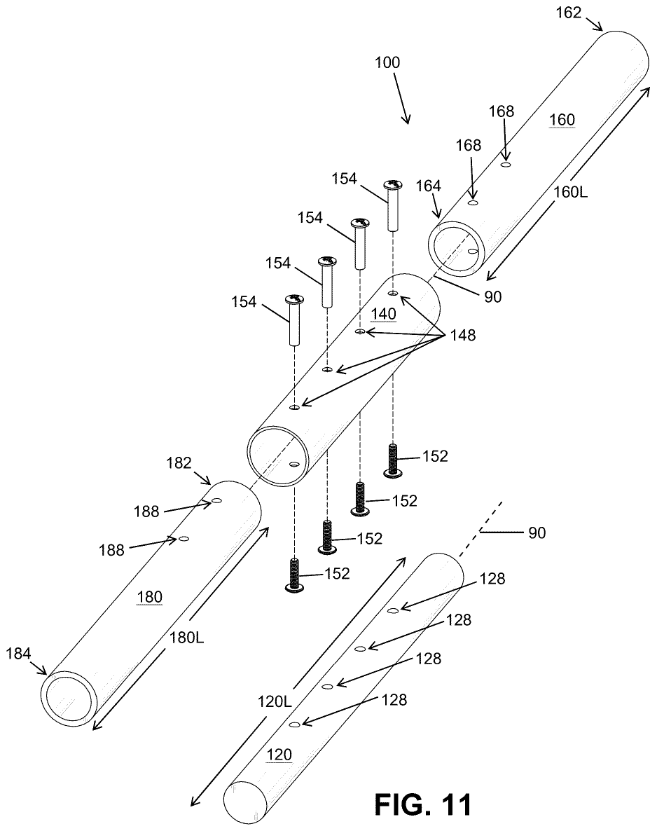

FIG. 1A is a perspective view showing the distal end of a connector system 100, according to at least one embodiment. The connector system 100 includes a core 120 that provides inner strengthening, a tube 140 that serves as an outer sleeve providing outer strengthening, fasteners 150 that maintain a coupling when assembled, and a first pole 160. The first pole 160 is intended to extend the effective reach of a digging tool, its length 160L (FIG. 11) being additive to the native handle, termed herein second pole 180, of a tool to which the connector system 100 is to be attached. The first pole 160 and second pole 180 are shown in short or partial view for illustration of other components in detail is a single drawing with other dimensions shown in a scale of utility in combination with existing tools. Users may find utility for a connector system 100 with a first pole 160 in any length 160L in conjunction with or without the second pole 180, also of any length 180L.

FIGS. 13-15 illustrate examples of digging tools, each having at least one tool head and attached handle referenced as a second pole 180. The digging tool in FIG. 13 is shown as a shovel with a shovel head 190. The digging tool in FIG. 14 is shown as a tamping tool with a tamping head 192. The digging tool in FIG. 15 is shown as a post hole digger having two blade heads 194, which are connected together by a hinge, and two respective handles each separately referenced as a second pole 180. The shovel head 190, tamping head 192, and blade heads 192 are non-limiting and non-exhaustive example of tool heads according to these descriptions.

The first pole 160 and second pole 180 are drawn and described similarly according to their interchangeability in at least some embodiments. Various modes of use may be inspired by these descriptions and/or embodiments of the poles and other elements made available to users. Various combinations of the elements in these descriptions and drawings are possible. In expressly described implementations described thus far, the illustrated assembly system 100 with the first pole 160 can be used to extend the effective reach of a digging tool, each having its own native handle referenced as poles 180 in FIGS. 13-15. In other implementations within the scope of these descriptions, the core 120, tube 140, and fasteners 150 are provided in a commercial product offering as mounted at the proximal ends 182 of the poles 180 in FIGS. 13-15, to which extending poles referenced as first poles 160 can be added to extend the effective reach of tools. In such cases, a pole 180 with mounted or provided core 120, tube 140, and fasteners 150 together constitute a connector system 100. Any number of poles in any arrangement and/or product offering with one or more of the other elements such as the tube and care are within the scope of these descriptions and the drawings.

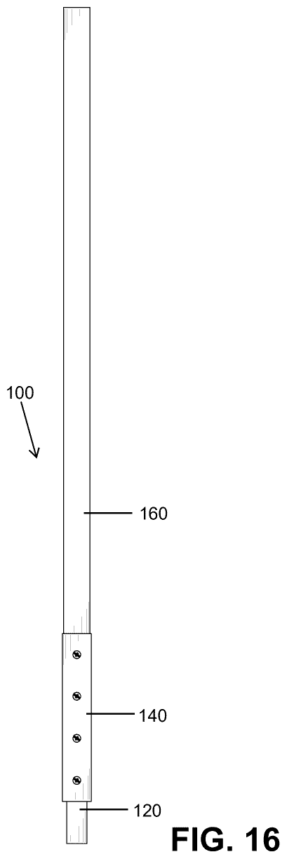

A version of the connector system 100 is shown in FIG. 16 at least approximately to scale for use with digging tools as represented in FIGS. 13-15 as non-limiting examples. FIG. 17 serves as a non-limiting example of use and a combined digging tool product 250, an initial view of which may foster an understanding of the connector system 100 before proceeding with respective descriptions of the several components of the system 100. The terms proximal and distal refer to a user perspective when using, for example, the combined digging tool product 250 of FIG. 17, in the use of which the termed proximal end 162 of the first pole 160 would be grasped by a user. Similarly by this nominal convention used consistently throughout these descriptions, the termed distal end 184 of the second pole 180 may be attached to a shovel blade or other digging element for use down hole and/or to extend reach. The terms dorsal and ventral are also nominally used herein in a way that is consistent but non-limiting with respect to how elements might be grasped and wielded by a user.+

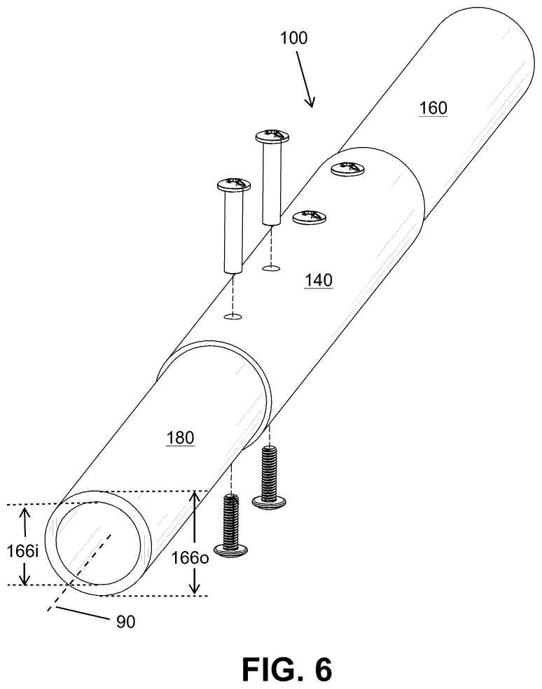

The illustrated first pole 160, and second pole 180, in some embodiments are hollow cylindrical lightweight durable items, each defining a longitudinal axis 90, and are shown as colinear in the drawings according to expected, but non-limiting, use of the connector system 100. The first pole 160 and second pole 180, in at least one embodiment, are each fabricated of composite fiberglass, having similar or same inner diameters 166i and outer diameters 166o (FIGS. 1B and 6). For example, the first pole 160 and second pole 180 may be cut from a same or similar tubular stock material and marketed by a same entity. Additional and/or alternatively, the connector system 100 may be dimensioned to couple to digging tools or second poles provided by another entity.

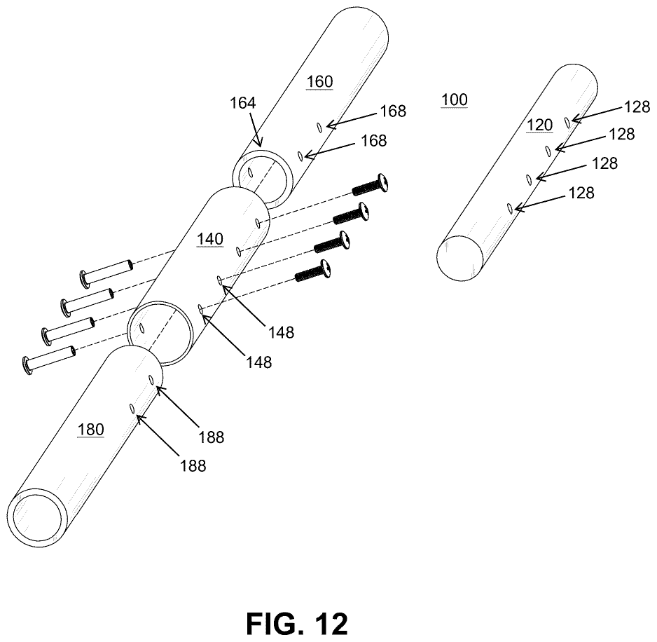

The core 120 strengthens the connector system 100 from within and is formed as a solid circular cylinder dimensioned to be received, along opposing approximate half portions, respectively within the cylindrical hollow interior of the first pole 160 and second pole 180. The uniform outer diameter 126 of the core 120 (FIG. 1A) is selected to matingly slip fit withing first pole 160 and second pole 180 for a snug and releasable insertion. The core 120 is shown separate from other components of the connector system 100 in the exploded view of FIGS. 11-12. The core 120 is illustrated as having four uniformly spaced, same diameter through holes 128 for fasteners 150. The through holes 128 are formed or bored as extending laterally, perpendicular to the longitudinal axis, and can be described as linearly arranged and mutually parallel. This feature, in conjunction with similarly arranged receiving holes defined through other components, makes assembly convenient for users. The user need not rotate the components and second pole 180 to many angles to accomplish coupling and assembly. In at least one embodiment, the core 120 is fabricated from wood along a natural axis thereof to take advantage of natural grain strength.

Like the core 120, the first pole 160 is illustrated as having uniformly spaced, same diameter holes for receiving the fasteners 150. These holes are termed mounting holes 168 (FIG. 11) for nominal differentiation. The mounting holes 168, two of which are shown in FIG. 11 and two of which are shown in FIG. 12, are formed through the wall of the first pole 160 near the distal end 164 and are arranged at positions to align with the ends of the through holes 128. Thus the four illustrated mounting holes 168 can be described as being two pairs of axially aligned holes 168, each pair axially aligned with a particular through hole 128 to receive a respective fastener upon assembly.

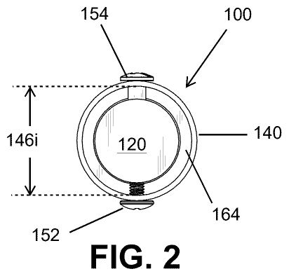

The tube 140 serves as an outer sleeve, provides outer strengthening, and is dimensioned to be receive, along opposing approximate half portions, ends of the first pole 160 and second pole 180. The uniform inner diameter 146i (FIG. 2) of the tube 140 is selected to matingly slip fit around the distal end of first pole 160 and the proximal end of the second pole 180 for a snug and releasable coupling. The tube 140 is shown separate from other components of the connector system 100 in the exploded view of FIGS. 11-12. The tube 140 is illustrated as having uniformly spaced receiving holes 148 for the fasteners 150. The receiving holes 148 are formed through the wall of the tube 140 at arranged positions to align with the ends of the through holes 128. The eight illustrated receiving holes 148 can be described as being four pairs of axially arranged holes, each pair aligned with a particular through hole 128 to receive a respective fastener upon assembly. The tube 140 can be fabricated of steel as a non-limiting example.

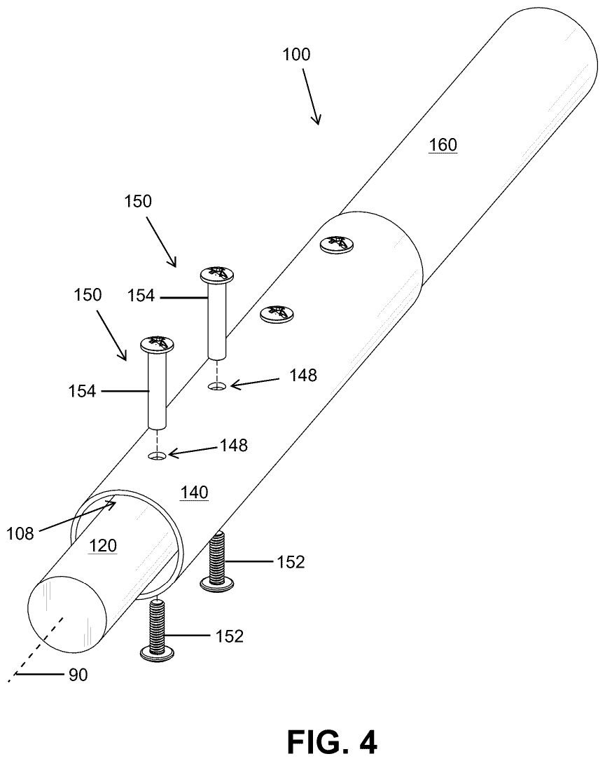

The fasteners 150 are illustrated each as having an externally threaded bolt 152 (FIGS. 4, 11) and internally threaded barrel nut 154. In particular, each bolt 152 is shown as having a head with a cross-shaped slot for turning by a Phillips screwdriver, and each barrel nut 154 is shown as having a head with a cross-shaped slot for turning by a Phillips screwdriver. Other example of fasteners are within the scope of these drawings.

There are four illustrated fasteners 150, two of which engage and fasten the distal end 164 of the first pole 160 to the core 120 and tube 140, and two others of which engage and fasten the proximal end 182 of the second pole 180 to the core 120 and tube 140. In the drawings, the bolts 152 are shown aligned with or inserted into the dorsal sides of the components of the connector system 100 and the barrel nuts 154 are shown aligned with or inserted into the ventral sides. Much symmetry is present in the connector system 100 such that a user need not be required to orient the connector system 100 and fasteners 150 in strict compliance with the drawings.

The two proximal through holes 128 of the core 120 align with the two corresponding proximal receiving holes 148 of the tube 140 and the two mounting holes near the distal end 164 of the first pole 160 in the assembled connector system 100. These refenced holes all receive the fasteners 150 thereby fixing the core 120, tube 140, and first pole 160 as a single item that can be mounted and dismounted interchangeably on various second poles 180, such as the handles of the digging tools in FIGS. 13-15. Alternatively, the poles 180 serving as native handles to the illustrated tools and those similar though not illustrated, may have the core 120 and tube 140 attached by fasteners 150 attached at their distal ends 182, to which first poles 160 may be coupled for reach extension.

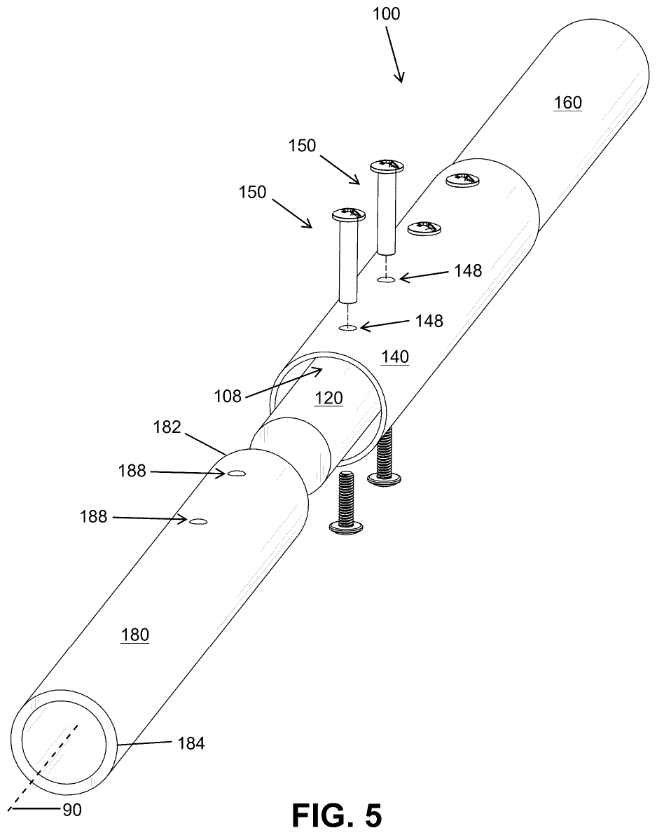

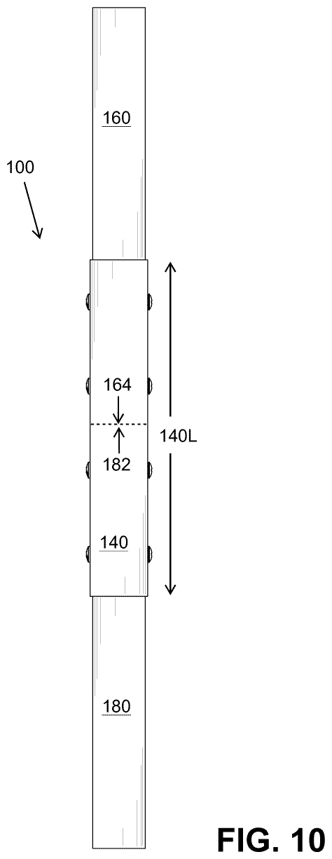

The proximal end 182 of the second pole 180 is to be inserted into the longitudinally extending annular space 108 (FIGS. 4-5) between the exterior surface of the core 120 and the interior of the wall of the tube 140. At full insertion, the proximal end 182 of the second pole 180 abuts the distal end 164 of the first pole 160. Their abutment, represented in dashed line in FIG. 10, is positioned at a longitudinal center position of the core 120 and within a longitudinal center position of the tube 140. Thus, in the illustrated embodiment of the connector system 100, approximately one half of the length 120L (FIG. 11) of the core 120 is received by the first pole 160 to align the through holes 128 and mounting holes 168. Furthermore, approximately a proximal half of the length 140L (FIG. 10) of the tube 140 receives a distal portion of the first pole 160, and distal half of the length 140L of the tube 140 receives a proximal portion of the second pole 180 upon assembly of the connector system 100 with the second pole 180.

The visible unoccupied receiving holes 148 in FIGS. 4-5, and the corresponding unoccupied but out-of-view through holes 128 of the core 120, are to align with two mounting 188 holes at the proximal end 182 of the second pole 180 (FIG. 5). The mounting holes 188 of the second pole 180 are for fixing the second pole 180 to the connector system 100. Aligning the various holes can be accomplished by rotation of the second pole 180 around the longitudinal axis 90 with the proximal end 182 of the second pole 180 inserted within the annular space 108 of the connector system 100 and abutting the first pole 160. In the illustrated embodiments, all of the mounting holes of the poles, and the receiving holes of the tube 140, are uniformly spaced to match the spacing of through holes 128 of the core 120, providing convenient interchangeability.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A connector system comprising:
a cylindrical core comprising a proximal end, a distal end, and a central portion between the proximal end and the distal end, the core extending along a longitudinal axis;
a cylindrical first pole extending along the longitudinal axis, the first pole comprising a proximal end, a distal end, and a cylindrical hollow interior in which the proximal end of the core is received; and
a cylindrical tube extending along the longitudinal axis, the tube comprising a proximal end, a distal end, and a cylindrical hollow interior in which the distal end of the first pole is received,
wherein an annular space is defined within the interior of the tube between the tube and core, the annular space extending longitudinally from the distal end of the first pole to the distal end of the tube, and
wherein the distal end of the core extends longitudinally beyond the distal end of the tube.

2. The connector system of claim 1, wherein the proximal end of the core extends longitudinally beyond the proximal end of the tube.

3. The connector system of claim 2, wherein approximately one half of a longitudinal length of the core is received by the interior of the first pole.

4. The connector system of claim 2, wherein approximately one half of a longitudinal length of the tube is received externally by the first pole.

5. The connector system of claim 1, further comprising at least one fastener received at least in part each of a hole defined of the tube, a hole defined by the first pole, and a hole defined by the core.

6. The connector system of claim 1, further comprising at least one fastener, wherein:
the core comprises multiple through holes, each through hole passing perpendicularly through the longitudinal axis, the through holes mutually parallel and spaced along the longitudinal axis by a uniform distance;
the first pole comprises multiple mounting holes spaced by the uniform distance, a particular mounting hole of said mounting holes being aligned with a particular through hole of said through holes;
the tube comprises multiple receiving holes spaced by the uniform distance, a particular receiving hole of said receiving holes being aligned with the particular mounting hole; and
the at least one fastener is received at least in part by each of the particular receiving hole, the particular mounting hole, and the particular through hole.

7. The connector system of claim 6, wherein the at least one fastener comprises a bolt and a barrel nut.

8. The connector system of claim 1, further comprising a cylindrical second pole extending along the longitudinal axis, the second pole comprising a proximal end received in the annular space, and a cylindrical hollow interior in which the distal end of the core is received.

9. The connector system of claim 8, wherein the distal end of the first pole abuts the proximal end of the second pole.

10. The connector system of claim 8, further comprising:
a first fastener received at least in part in each of a first receiving hole defined by the tube, a mounting hole defined by the first pole, and a first through hole defined by the core; and
a second fastener received at least in part in each of a second receiving hole defined by the tube, a mounting hole defined by the second pole, and a second through hole defined by the core.

11. The connector system of claim 8, further comprising a tool head attached to the distal end of the second pole.

12. The connector system of claim 1, further comprising a cylindrical third pole extending along the longitudinal axis, the third pole comprising a proximal end coupled to a distal end of the cylindrical second pole.

13. The connector system of claim 1, wherein the cylindrical core comprises a solid cylindrical core.

14. The connector system of claim 1, wherein at least one of:
the cylindrical core comprise wood;
the first pole comprises a fibrous composite; and
the tube comprises steel.

15. A tool system comprising:
a cylindrical solid core comprising a proximal end, a distal end, and a central portion between the proximal end and the distal end, the core extending along a longitudinal axis;
a cylindrical first pole extending along the longitudinal axis, the first pole comprising a proximal end, a distal end, and a cylindrical hollow interior in which the proximal end of the core is received; and
a cylindrical tube extending along the longitudinal axis, the tube comprising a proximal end, a distal end, and a cylindrical hollow interior in which the distal end of the first pole is received,
wherein an annular space is defined within the interior of the tube between the tube and core, the annular space extending longitudinally from the distal end of the first pole to the distal end of the tube, and
a cylindrical second pole comprising a proximal end configured to be received in the annular space, a distal end, and a cylindrical hollow interior configured to receive the distal end of the core.

16. The tool system of claim 15, wherein the proximal end of the core extends longitudinally beyond the proximal end of the tube, and the distal end of the core extends longitudinally beyond the distal end of the tube.

17. The tool system of claim 16, wherein approximately a first half of a longitudinal length of the core is received by the interior of the first pole.

18. The tool system of claim 16, wherein approximately a first half of a longitudinal length of the tube is received by an exterior of the first pole.

19. The tool system of claim 15, further comprising at least one fastener, wherein:
the core comprises multiple through holes, each through hole passing perpendicularly through the longitudinal axis, the through holes mutually parallel and spaced along the longitudinal axis by a uniform distance;
the first pole comprises multiple mounting holes spaced by the uniform distance, a particular mounting hole of said mounting holes being aligned with a particular through hole of said through holes;
the tube comprises multiple receiving holes spaced by the uniform distance, a particular receiving hole of said receiving holes being aligned with the particular mounting hole; and
the at least one fastener is received at least in part by each of the particular receiving hole, the particular mounting hole, and the particular through hole.

20. The tool system of claim 19, wherein the at least one fastener comprises a bolt and a barrel nut.

21. The tool system of claim 15, further comprising a tool head attached to the distal end of the second pole.
